(19) United States
(12) Patent Application Publication
(10) Pub. No.: US 2016/0259860 A1
(43) Pub. Date: Sep. 8, 2016

(54) AUTOMOTIVE SEARCH PLATFORM

(71) Applicant: Autoist LLC, Denver, CO (US)

(72) Inventors: Chris Loar, Denver, CO (US); Anthony Hildoer, Castle Rock, CO (US)

(21) Appl. No.: 15/065,605

(22) Filed: Mar. 9, 2016

Related U.S. Application Data
(63) Continuation-in-part of application No. 14/864,576, filed on Sep. 24, 2015, now abandoned.
(60) Provisional application No. 62/054,822, filed on Sep. 24, 2014.

(51) Int. Cl. G06F 17/30; G06Q 30/06

(52) U.S. Cl. CPC G06F 17/30867; G06F 17/30554; G06Q 30/0613

(57) ABSTRACT

Embodiments directed to systems and methods for use in identifying vehicle listings within a distributed network. In one aspect, an embodiment including first searching, over one or more networks, a plurality of first remote listing sources for first vehicle listing data, the first vehicle data including a plurality of data segments defined by a different respective format. The embodiments may further include first normalizing the plurality of data segments of the first vehicle listing data such that the plurality of data segments may be defined by a common data format. The embodiments may further include first indexing the normalized first vehicle listing data according to the listing attribute of at least one of the data segments of the plurality of data segments. The embodiments may further include storing the indexed first vehicle listing data in a database of a listing server.

### CROSS-REFERENCE TO RELATED APPLICATION

This application is a continuation-in-part of U.S. patent application Ser. No. 14/864,576 entitled “Automotive Search Platform,” filed on Sep. 24, 2015, which claims priority from U.S. Provisional Application No. 62/054,822 filed on Sep. 24, 2014, entitled “AUTOMOTIVE SEARCH PLATFORM,” the contents of which are incorporated by reference herein as if set forth in full.

### FIELD

Systems and methods presented herein relate generally to the provision of search results identified across of a plurality of sources of a distributed network.

### BACKGROUND

Various data sources (e.g., websites, etc.) interconnected via a distributed network (e.g., the Internet) may contain data indicative of a vehicle for sale. In this regard, the various data sources may include unique, but not mutually exclusive, data sets indicative of a plurality of vehicles for sale. As may be appreciated, such unique data sets at each of the various data sources may impede searching for a particular vehicle of interest (e.g., for at least because it may be unknown as to which of the various data sources may include data corresponding to the vehicle of interest). Further, such data sets may be stored and represented at each of the various data sources in different respective data formats. This, in turn, may hinder searching the totality of various data sources in any comprehensive manner for a particular vehicle for sale (e.g., the data from a first data source may be formatted in a manner different from that of a second data source, even where the data at each of the first and second data sources is indicative of the same vehicle for sale).

### SUMMARY

In view of the foregoing, a primary objective of the present disclosure is to provide systems and methods for identifying vehicle listings in a distributed network, thereby facilitating improved retrieval of vehicle listing data stored at various listing sources.

In one aspect, the present disclosure includes a method for use in identifying vehicle listings within a distributed network. The method includes, first searching, over one or more networks, a plurality of first remote listing sources for first vehicle listing data. The first vehicle listing data may include a plurality of data segments. In this regard, each data segment of the plurality of data segments may represent a listing attribute of the respective remote listing source and be defined by a different respective data format. The method further includes storing the first vehicle listing data in a database of a listing server. The method further includes receiving, at a processor of the listing server, after the storing, search criteria from a user. The method further includes identifying, by the processor, associations between the stored vehicle listing data and the search criteria. The method further includes returning a listing result that is at least partially based on the identified associations.

A number of feature refinements and additional features are applicable in the first aspect and contemplated in light of the present disclosure. These feature refinements and additional features may be used individually or in any combination. As such, each of the following features that will be discussed may be, but are not required to be, used with any other feature combinations of the first aspect.

In one embodiment, the first searching may include identifying the first vehicle listing data associated with each respective one of the plurality of first remote listing sources. In this regard, the method may further include determining a subset of the identified first vehicle listing data associated with each respective one of the plurality of first remote listing sources as active listings. The storing may therefore include accessing the active listings such that the active listings are stored in the database. The active listings may correspond to instances of the identified first vehicle listing data that are not recognized as being previously stored at the database.

For example, in an embodiment, the method may further include first normalizing, by the processor, the plurality of data segments of the first vehicle listing data such that the plurality of data segments are defined by a common data format. The method may further include first indexing, by the processor, the normalized first vehicle listing data according to the listing attribute of at least one of the data segments of the plurality of data segments. As such, the listing result is at least partially based on the indexed first vehicle listing data. For example, in one implementation, a first segment of first vehicle listing data may be defined by a first data format that identifies a first vehicle, and a second segment of first vehicle listing data may be defined by a second data format that identifies the first vehicle. In this regard, while the first and second data formats may be different, the first and second segments of first vehicle listing data may be defined by the common data format after the first normalizing. Further, the first normalizing may include accessing a source driver for each of the plurality of first remote listing sources that translates each data segment associated with the respective source into the common data format. Each of the translated data segments may include a canonical listing object.

In another embodiment, the method further includes second searching, in response to the receiving, a plurality of second remote vehicle listing sources for second vehicle listing data. Each of the plurality of second remote listing sources may include at least one data definition corresponding to a listing attribute of the respective second remote listing source. In turn, the second vehicle listing data may include the subset of the plurality of second remote listing sources corresponding to the search criteria.

In this regard, the method may further include second normalizing, by the processor, the second vehicle listing data such that the at least one data definition of each of the plurality of second remote listing sources conforms to the common data format. The method may further include second indexing, by the processor, the normalized second vehicle listing data according to the at least one data definition of the plurality of first remote listing sources. As such, the storing may further include storing the indexed second vehicle listing data with the first indexed vehicle listing data in the database of the listing server. In turn, the listing result is at least partially based on the indexed second vehicle listing data.

Further, the normalized first vehicle listing data and the normalized second vehicle listing data may be associated with GPS data corresponding to a physical location associated with the first vehicle listing data or the second vehicle listing data. As such, the listing result may be at least partially based on the GPS data.

In another embodiment, the normalized first vehicle listing data and the normalized second vehicle listing data may be associated with analytics data. The analytics data may be at least partially based on the listing attribute of the respective first remote listing source or the listing attribute of the respective second remote listing source. As such, the listing result may be at least partially based on the analytics data. Notably, the analytics data may include price data received from a third-party source distinct from any of the plurality of first remote listing sources of the plurality of second remote listing sources.

In yet another embodiment, the storing may include saving the search criteria from the user in the database. As such, the processor may be operable to return the listing result at least partially based on the saved user criteria. Further, the returning may include providing an alert to the user in response to the returning of the listing result. In some instances, this alert may be associated with the transmission of the listing results to a remote device. Additionally, the first searching may include at least one of web crawling, data scrapping, or API-based data extraction.

In another instance, the method may further include updating the stored vehicle listing data in part by comparing the stored vehicle listing data with a corresponding one of the first vehicle listing data maintained at the respective one of the plurality of first remote listing sources.

In this regard, a second aspect of the present disclosure includes a computer executed system on a computing device for identifying vehicle listings within a distributed network. The system includes a collection module, executed by a processor of the computer executed system, that is operative to first search a plurality of first remote listing sources for first vehicle listing data and store the first vehicle listing data in a database of the system. The first vehicle listing data may include a plurality of data segments. In this regard, each data segment of the plurality of data segments may represent a listing attribute of the respective first remote listing source and may be defined by a different respective data format. The system further includes a search engine controller, executed by the processor of the computer executed system, that is configured to receive search criteria from a user. The system further includes a listing broker engine, executable by the processor of the computer executed system, that is configured to: (a) identify associations between the first vehicle listing data and the received search criteria, and (b) return a listing result that is at least partially based on the identified associations.

A number of feature refinements and additional features are applicable in the second aspect and contemplated in light of the present disclosure. These feature refinements and additional features may be used individually or in any combination. As such, each of the following features that will be discussed may be, but are not required to be, used with any other feature combinations of the second aspect.

In one embodiment, the collection module may be further configured to identify the first vehicle listing data associated with each respective one of the plurality of first remote listing sources. The collection module may be further configured to determine a subset of the identified first vehicle listing data associated with each respective one of the plurality of first remote listing sources as active listings. The collection module may be further configured to access the active listings such that the active listings are stored in the database. In this regard, the active listings may correspond to instances of the identified first vehicle listing data that are not recognized as being previously stored at the database.

For example, in an embodiment, the collection module may be further configured to first normalize, by the processor, the plurality of data segments of the first vehicle listing data such that the plurality of data segments may be defined by a common data format. In this regard the listing broker engine may be further configured to first index, by the processor, the normalized first vehicle listing data according to the listing attribute of at least one of the data segments of the plurality of data segments. As such, the listing result may be at least partially based on the indexed first vehicle listing data. As an example, in one implementation, a first segment of first vehicle listing data may be defined by a first data format that identifies a first vehicle, and a second segment of first vehicle listing data may be defined by a second data format that identifies the first vehicle. In this regard, while the first and second data formats may be different, the first and second segments of first vehicle listing data may be defined by the common data format after the first normalize by the processor. Further, the collection module may be configured to access a source driver for each of the plurality of first remote listing sources that translates each data segment associated with the respective source into the common data format. Each of the translated data segments may include a canonical listing object.

In another embodiment, the collection module may be further configured to second search, in response to the received search criteria from the user, a plurality of second remote vehicle listing sources for second vehicle listing data. In this regard, each of the plurality of second remote listing sources may include at least one data definition corresponding to a listing attribute of the respective second remote listing source, and the second vehicle listing data may include the subset of the plurality of second remote listing sources corresponding to the search criteria.

In this regard, the collection module may be further configured to second normalize the second vehicle listing data such that the at least one data definition of each of the plurality second remote listing sources conforms to the common data format. The listing broker engine may be further configured to second index the normalized second vehicle listing data according to the at least one data definition of the plurality of first remote listing sources. As such, the database may be further configured to store the indexed second vehicle listing data with the indexed vehicle listing data. In turn, the listing result may be at least partially based on the normalized vehicle listing data.

Further, the normalized first vehicle listing data and the normalized second vehicle listing data may be associated with GPS data corresponding to a physical location associated with the first vehicle listing data and the second vehicle listing data. As such, the listing result may be at least partially based on the GPS data.

In another embodiment, the normalized first vehicle listing data and the normalized second vehicle listing data may be associated with analytics data. The analytics data may be at least partially based on the listing attribute of the respective first remote listing source or the listing attribute of the respective second remote listing source. As such, the listing result may be at least partially based on the analytics data. Further, the analytics data may include price data received from a third-party source distinct from any of the first plurality of remote listing sources or the plurality of second remote listing sources.

In yet another embodiment, the database is further configured to save the search criteria from the user. As such, the listing broker engine may be further configured to return the listing result at least partially based on the saved user criteria. The listing broker engine may be further configured to provide an alert to the user in response to the returning of the listing result. In some instances, this alert may be associated with the transmission of the listing results to a remote device. In one implementation, the collection module may be further configured to first search the plurality of first remote listing sources for first vehicle listing data via at least one of web crawling, data scrapping, or API-based data extraction.

In another instance, the listing broker engine is further configured to update the stored vehicle listing data in part by comparing the stored vehicle listing data with a corresponding one of the first vehicle listing data maintained at the respective one of the plurality of first remote listing sources.

In this regard, a third aspect of the present disclosure includes a method for use in identifying vehicle listings within a distributed network. The method includes first searching, over one or more networks, a plurality of first remote listing sources for first vehicle listing data. The first vehicle listing data may include a plurality of data segments. Each data segment of the plurality of data segments may represent a listing attribute of the respective first remote listing source and may be defined by a different respective data format. The method further includes first normalizing, at a processor of the listing server, the plurality of data segments of the first vehicle listing data such that the plurality of data segments may defined by a common data format. The method further includes first indexing, by the processor, the normalized first vehicle listing data according to the listing attribute of at least one of the data segments of the plurality of data segments. The method further includes storing the indexed first vehicle listing data in a database of a listing server.

A number of feature refinements and additional features are applicable in the third aspect and contemplated in light of the present disclosure. These feature refinements and additional features may be used individually or in any combination. As such, each of the following features that will be discussed may be, but are not required to be, used with any other feature combinations of the third aspect.

In one embodiment, the first searching includes identifying the first vehicle listing data associated with each respective one of the plurality of first remote listing sources. In this regard, the method may further include determining a subset of the identified first vehicle listing data associated with each respective one of the plurality of first remote listing sources as active listings. The storing may include accessing the active listings such that the active listings are stored in the database. The active listings may correspond to instances of the identified first vehicle listing data that are not recognized as being previously stored at the database. Further, the first normalizing may include accessing a source driver for each of the plurality of first remote listing sources that translates each data segment associated with the respective source into the common data format. Each of the translated data segments may include a canonical listing object.

For example, in an embodiment, the method may further include receiving, by the processor, search criteria for a user. The method further includes identifying, by the processor, associations between the stored vehicle listing data and the search criteria. The method further includes returning a listing result that is at least partially based on the identified associations. In one implementation, a first segment of first vehicle listing data may be defined by a first data format that identifies a first vehicle, and a second segment of first vehicle listing data may be defined by a second data format that identifies the first vehicle. In this regard, while the first and second data formats may be different, the first and second segments of first vehicle listing data may be defined by the common data format after the first normalizing.

In another embodiment, the method further includes second searching, in response to the receiving, a plurality of second remote vehicle listing sources for second vehicle listing data. Each of the plurality of second remote listing sources may include at least one data definition corresponding to a listing attribute of the respective second remote listing source, and the second vehicle listing data may include the subset of the plurality of second remote listing sources corresponding to the search criteria.

In this regard, the method may further include second normalizing, by the processor, the second vehicle listing data such that the at least one data definition of each of the plurality of second remote listing sources conforms to the common data format. The method may further include second indexing, by the processor, the normalized second vehicle listing data according to the at least one data definition of the plurality of first remote listing sources. As such, the storing further includes storing the indexed second vehicle listing data with the indexed vehicle listing data in the database of the listing server. In this regard, the listing result may be at least partially based on the normalized second vehicle listing data.

Further, the normalized first vehicle listing data and the normalized second vehicle listing data may be associated with GPS data corresponding to a physical location associated with the first vehicle listing data or the second vehicle listing data. As such, the listing result may be at least partially based on the GPS data.

In another embodiment, the normalized first vehicle listing data and the normalized second vehicle listing data may be associated with analytics data. The analytics data may be at least partially based on the listing attribute of the respective first remote listing source or the listing attribute of the respective second remote listing source. As such, the listing result is at least partially based on the analytics data. In this regard, the analytics data may include price data received from a third-party source distinct from any of the plurality of first remote listing sources or the plurality of second remote listing sources.

In yet another embodiment, the storing may include saving the search criteria from the user in the database. As such, the processor may be operable to return the listing result at least partially based on the saved user criteria. Further, the returning may include providing an alert to the user in response to the returning of the listing result. In some instances, this alert may be associated with the transmission of the listing results to a remote device. In one implementation, the first searching includes at least one of web crawling, data scrapping, or API-based data extraction.

In another instance, the method may further include updating the stored vehicle listing data in part by comparing the stored vehicle listing data with a corresponding one of the first vehicle listing data maintained at the respective one of the first plurality of remote listing sources.

In this regard, a fourth aspect of the present disclosure includes a computer executed system on a computing device for identifying vehicle listings within a distributed network. The system includes a collection module, executed by a processor of the computer executed system, that is operative to: (a) first search a plurality of first remote listing source for first vehicle listing data. The first vehicle listing data may include a plurality of data segments, where each data segment of the plurality of data segments may represent a listing attribute of the respective first listing source and may be defined by a different respective data format; (b) first normalize the plurality of data segments of the first vehicle listing data such that the plurality of data segments are defined by a common data format; and (c) first index the normalized first vehicle listing data according to the listing attribute of at least one of the data segments of the plurality of data segments. The system further includes a database configured to store the indexed first vehicle listing data in a database of a listing server.

A number of feature refinements and additional features are applicable in the fourth aspect and contemplated in light of the present disclosure. These feature refinements and additional features may be used individually or in any combination. As such, each of the following features that will be discussed may be, but are not required to be, used with any other feature combinations of the fourth aspect.

In one embodiment, the collection module may be further configured to identify the first vehicle listing data associated with each respective one of the plurality of first remote listing sources. The collection module may be further configured to determine a subset of the identified first vehicle listing data associated with each respective one of the plurality of first remote listing sources as active listings. The collection module may be further configured to access the active listings such that the active listings are stored in the database. The active listings may therefore correspond to instances of the identified first vehicle listing data that are not recognized as being previously stored at the database. Further, the collection module may be configured to access a source driver for each of the plurality of first remote listing sources that translates each data segment associated with the respective source into the common data format. Each of the translated data segments may include a canonical listing object.

For example, in an embodiment, the system may further include a search engine controller, executable by the processor of the computer executed system, that may be configured to receive search criteria for a user. The system may further include a listing broker engine that is configured to: (a) identify associations between the stored vehicle listing data and the search criteria; and (b) return a listing result that is at least partially based on the associations. In one implementation, a first segment of first vehicle listing data may be defined by a first data format that identifies a first vehicle, and a second segment of first vehicle listing data may be defined by a second data format that identifies the first vehicle. In this regard, while the first and second data formats may be different, the first and second segments of first vehicle listing data may be defined by the common data format after the first normalize by the listing broker engine.

In another embodiment, the collection module may be further configured to second search, in response to the received search criteria from the user, a plurality of second remote vehicle listing sources for second vehicle listing data. Each of the plurality of second remote listing sources may include at least one data definition corresponding to a listing attribute of the respective second remote listing source, and the second vehicle listing data may include the subset of the plurality of second remote listing sources corresponding to the search criteria.

In this regard, the collection module may be further configured to second normalize the second vehicle listing data such that the at least one data definition of each of the plurality second remote listing sources conforms to the common data format. The listing broker engine may be further configured to second index the normalized second vehicle listing data according to the at least one data definition of the plurality of first remote listing sources. As such, the database may be further configured to store the indexed second vehicle listing data with the indexed vehicle listing data. In turn, the listing result may be at least partially based on the normalized vehicle listing data.

Further, the normalized first vehicle listing data and the normalized second vehicle listing data may be associated with GPS data corresponding to a physical location associated with the first vehicle listing data and the second vehicle listing data. As such, the listing result may be at least partially based on the GPS data.

In another embodiment, the normalized first vehicle listing data and the normalized second vehicle listing data may be associated with analytics data. The analytics data may be at least partially based on the listing attribute of the respective first remote listing source or the listing attribute of the respective second remote listing source. As such, the listing result may be at least partially based on the analytics data. Further, the analytics data may include price data received from a third-party source distinct from any of the first plurality of remote listing sources or the plurality of second remote listing sources.

In yet another embodiment, the database may be further configured to save the search criteria from the user. As such, the listing broker engine may be further configured to return the listing result at least partially based on the saved user criteria. The listing broker engine may be further configured to provide an alert to the user in response to the returning of the listing result. In some instances, this alert may be associated with the transmission of the listing results to a remote device. In one implementation, the collection module is further configured to first search the plurality of first remote listing sources for first vehicle listing data via at least one of web crawling, data scrapping, or API-based data extraction.

In another instance, the listing broker engine may be further configured to update the stored vehicle listing data in part by comparing the stored vehicle listing data with a corresponding one of the first vehicle listing data maintained at the respective one of the plurality of first remote listing sources.

In this regard, a fifth aspect of the present disclosure includes a method for use in identifying vehicle listings within a distributed network. The method further include establishing search criteria in relation to a search for a vehicle. The method further includes transmitting, over the distributed network, the search criteria to a processor of a listing server for identifying associations between stored vehicle listing data and the search criteria. The stored vehicle listing data may be stored at a database of the listing server and may be generated from a first search of a plurality of first remote listing sources for first vehicle listing data. The first vehicle listing data may include a plurality of data segments. Further, each data segment of the plurality of data segments may represent a listing attribute of the respective first remote listing source and may be defined by a different respective data format. The method further includes receiving a listing result that is at least partially based on the identified association.

A number of feature refinements and additional features are applicable in the fifth aspect and contemplated in light of the present disclosure. These feature refinements and additional features may be used individually or in any combination. As such, each of the following features that will be discussed may be, but are not required to be, used with any other feature combinations of the fifth aspect.

In one embodiment, the first search may include identifying, by the processor of the listing server, the first vehicle listing data associated with each respective one of the plurality of listing sources. The processor of the listing server may be configured to determine a subset of the identified first vehicle listing data associated with each respective one of the plurality of remote listing sources as active listings. The processor of the listing server may be configured to store the active listing such that the stored vehicle listing data includes the active listings. In this regard, the active listings may correspond to instances of the identified first vehicle listing data that are not recognized as being previously stored at the database.

For example, in an embodiment, a processor of the listing server may be configured to first normalize the plurality of data segments of the first vehicle listing data such that the plurality of data segments are defined by a common data format. The processor of the listing server may be further configured to first index the normalized first vehicle listing data according to the listing attribute of at least one of the data segments of the plurality of data segments. As such, the listing result may be at least partially based on the indexed first vehicle listing data. In one implementation, a first segment of first vehicle listing data may be defined by a first data format that identifies a first vehicle, and a second segment of first vehicle listing data may be defined by a second data format that identifies the first vehicle. In this regard, while the first and second data formats may be different, the first and second segments of first vehicle listing data may be defined by the common data format after the first normalize by the processor. Further, the first normalizing may include accessing, by the processor of the listing server, a source driver for each of the plurality of first remote listing sources that translates each data segment associated with the respective source into the common data format. Each of the translated data segments may include a canonical listing object.

In another embodiment, the processor of the listing server, in response to the transmitting, may be further configured to second search a plurality of second remote vehicle listing sources for second vehicle listing data. Each of the plurality of second remote listing sources may include at least one data definition corresponding to a listing attribute of the respective second remote listing source, and the second vehicle listing data may include the subset of the plurality of second remote listing sources corresponding to the search criteria.

In this regard, the processor of the listing server may be further configured to second normalize the second vehicle listing data such that the at least one data definition of each of the plurality of second remote listing sources conforms to the common data format. The processor of the listing server may be further configured to second index the normalized second vehicle listing data according to the at least one data definition of the plurality of first remote listing sources. As such, the database of the listing server may be configured to store the indexed second vehicle listing data with the indexed first vehicle listing data. As such, the listing result may be at least partially based on the indexed second vehicle listing data.

Further, the normalized first vehicle listing data and the normalized second vehicle listing data may be associated with GPS data corresponding to a physical location associated with the first vehicle listing data or the second vehicle listing data. As such, the listing result may be at least partially based on the GPS data.

In another embodiment, the normalized first vehicle listing data and the normalized second vehicle listing data may be associated with analytics data. The analytics data may be at least partially based on the listing attribute of the respective first remote listing source or the listing attribute of the respective second remote listing source. As such, the listing result may be at least partially based on the analytics data. In turn, the analytics data may include price data received from a third-party source distinct from any of the plurality of first remote listing sources of the plurality of second remote listing sources.

In yet another embodiment, the database may be configured to store the search criteria from the user in the database. As such, the processor may be operable to return the listing result at least partially based on the saved user criteria. Further, the receiving may include receiving an alert associated with the listing result. In some instances, this alert may be associated with the transmission of the listing results to a remote device. In one implementation, the first search may include at least one of web crawling, data scrapping, or API-based data extraction.

In another instance, the processor of the listing server is configured to update the stored vehicle listing data in part by comparing the stored vehicle listing data with a corresponding one of the first vehicle listing data maintained at the respective one of the plurality of first remote listing sources.

In this regard, a sixth aspect of the present disclosure includes a computer executed system on a computing device for identifying vehicle listings within a distributed network. The system includes an access terminal remote from an in operative communication with a computer executed listing server. In this regard, the listing server may be operable to receive search criteria in relation to a search for a vehicle established by a user at the access terminal. In turn, the listing server may be operable to identify associations between stored vehicle listing data and the search criteria. The stored vehicle listing data may be stored at a database of the listing server and may be generated from a first search, executed by a collection module of the listing server, of a plurality of first remote listing sources for first vehicle listing data. Further, the first vehicle listing data may include a plurality of data segments. Notably, each data segment of the plurality of data segments may represent a listing attribute of the respective first remote listing source and defined by a different respective data format. The system further includes a user interface provided at the access terminal for receiving a listing result, generated by a listing broker engine of the listing server, based on the identified associations.

A number of feature refinements and additional features are applicable in the sixth aspect and contemplated in light of the present disclosure. These feature refinements and additional features may be used individually or in any combination. As such, each of the following features that will be discussed may be, but are not required to be, used with any other feature combinations of the sixth aspect.

In one embodiment, the collection module may be further configured to identify the first vehicle listing data associated with each respective one of the plurality of first remote listing sources. The collection module may be further configured to determine a subset of the identified first vehicle listing data associated with each respective one of the plurality of first remote listing sources as active listings. The collection module may be further configured to access the active listings such that the active listings are stored in the database. In this regard, the active listings may correspond to instances of the identified first vehicle listing data that are not recognized as being previously stored at the database.

For example, in an embodiment, the collection module may be configured to first normalize the plurality of data segments of the first vehicle listing data such that the plurality of data segments are defined by a common data format. The listing broker engine may be further configured to first index the normalized first vehicle listing data according to the listing attribute of at least one of the data segments of the plurality of data segments. As such, the listing result may be at least partially based on the indexed first vehicle listing data. In one implementation, a first segment of first vehicle listing data may be defined by a first data format that identifies a first vehicle, and a second segment of first vehicle listing data may be defined by a second data format that identifies the first vehicle. In this regard, while the first and second data formats may be different, the first and second segments of first vehicle listing data may be defined by the common data format after the first normalize by the listing broker engine. Further, the collection module may be further configured to access a source driver for each of the plurality of first remote listing sources that translates each data segment associated with the respective source into the common data format. Each of the translated data segments may include a canonical listing object.

In another embodiment, the collection module, in response to the search criteria established by the user at the access terminal, may be configured to second search a plurality of second remote vehicle listing sources for second vehicle listing data. Each of the plurality of second remote listing sources may include at least one data definition that corresponds to a listing attribute of the respective second remote listing source, and the second vehicle listing data may include the subset of the plurality of second remote listing sources corresponding to the search criteria.

In this regard, the listing broker engine may be further configured to second normalize the second vehicle listing data such that the at least one data definition of each of the plurality of second remote listing sources conforms to the common data format. The listing broker engine may be further configured to second index the normalized second vehicle listing data according to the at least one data definition of the plurality of first remote listing sources. As such, the database of the listing server may be configured to store the indexed second vehicle listing data with the indexed first vehicle listing data. In turn, the listing result may be at least partially based on the indexed second vehicle listing data.

Further, the normalized first vehicle listing data and the normalized second vehicle listing data may be associated with GPS data corresponding to a physical location associated with the first vehicle listing data or the second vehicle listing data. As such, the listing result may be at least partially based on the GPS data.

In another embodiment, the normalized first vehicle listing data and the normalized second vehicle listing data may be associated with analytics data. The analytics data may be at least partially based on the listing attribute of the respective first remote listing source or the listing attribute of the respective second remote listing source. As such, the listing result may be at least partially base on the analytics data. Further, the analytics data may include price data received from a third-party source distinct from any of the plurality of first remote listing sources of the plurality of second remote listing sources.

In yet another embodiment, the database may be configured to store the search criteria from the user in the database. As such, the listing broker engine may be operable to return the listing result at least partially based on the saved user criteria. Further, the user interface may be configured to receive an alert associated with the listing result. In one implementation, the first search may include at least one of web crawling, data scrapping, or API-based data extraction.

In another instance, the listing broker engine may be further configured to update the stored vehicle listing data in part by comparing the stored vehicle listing data with a corresponding one of the first vehicle listing data maintained at the respective one of the plurality of first remote listing sources.

In addition to the exemplary aspects and embodiments described above, further aspects and embodiments will become apparent by reference to the drawings and by study of the following descriptions.

### DESCRIPTION OF THE DRAWINGS

For a more complete understanding of the present invention and further advantages thereof, reference is now made to the following Detailed Description, taken in conjunction with the drawings, in which:

FIG. 1 is a functional block diagram of a system for identifying vehicle listings within a distributed network, according to one embodiment.

FIG. 2 is a more detailed functional block diagram of a listing server of the system of FIG. 1 for processing incoming data collected in the distributed network.

FIG. 3a illustrates with a flow diagram an embodiment of a method for use in identifying vehicle listings within a distributed network from a plurality of pre-search sources.

FIG. 3b illustrates with a flow diagram an embodiment of a method for use in identifying vehicle listings within a distributed network from a plurality of real-time search sources.

FIG. 4 illustrates with a flow diagram an embodiment of a method for use in identifying vehicle listings within a distributed network from a plurality of aggregated pre-search sources and real-time search sources based on received user criteria.

FIG. 5 illustrates with a flow diagram an embodiment of a method for use in identifying a vehicle listing in the distributed network of FIG. 1 based on saved user search criteria.

FIG. 6 illustrates with a system implementation picture an embodiment of the user interface of the system of FIG. 2.

FIG. 7 illustrates with a system implementation picture an embodiment of the user interface, of the system of FIG. 6, on a plurality of wireless devices.

### DESCRIPTION OF THE INVENTION

Disclosed herein are utilities (e.g., systems, processes, etc.) for identifying vehicle listings from a plurality of disparate listing sources within a distributed network and generating a listing result at least partially based on received user criteria. The disclosed utilities employ a processor to browse a plurality of remote “pre-search” vehicle listing sources to identify pre-search source data (e.g., first vehicle listing data) associated with vehicle listings in advance of a user search. That is, the pre-search sources are listing sources (e.g., servers, etc.) that may be collected continuously (e.g., by web crawling, data scraping, and the like) according to any appropriate schedule, but not in response to a user query. The pre-search source data may be normalized and used to build an indexable database, in which the pre-search source data is translated into a common data structure. In turn, the indexable database of pre-search source data may be subsequently searched in response to a user query. Furthermore, a plurality of “real-time” search sources may be collected or searched for criteria-specific data (e.g., second vehicle listing data) associated with vehicle listings of the plurality of real-time search sources. In this regard, real-time sources are listing sources that are searched in direct response to a user query. The pre-search sources and real-time sources may be combinatively stored in a database of a listing server, such as in a temporary cache file for immediate access by a user. By filtering the indexable database based on associations between the user criteria and the pre-search source data, an aggregated listing result may be generated at least partially based on pre-search source data and/or criteria-specific data from the real-time search source.

More broadly, the disclosed embodiments relate to returning a listing result based on data accessed from a plurality of disparate data sources (e.g., pre-search data, and/or criteria-specific data, etc.). For example, the invention may be used to identify vehicle listings (e.g., current or active vehicle listings, vehicle listings corresponding to a user search, etc.) at each of a plurality of data sources in order to extract the vehicle listing for subsequent manipulation and presentation to a user. In this regard, rather than monitor each data source manually, the access provided by the invention allows a user to identify relevant vehicle listings across all of the plurality of data sources in an efficient and effective manner not otherwise obtainable by traditional means. Normalizing the identified vehicle listings facilitates the foregoing in part by providing a common metric by which to compare disparate sets of vehicle data despite the data sets originating from data sources that employ different data formats. Accordingly, the invention performs a comprehensive search for vehicle listings within the distributed network by facilitating access to disparate date sets, normalizing and analyzing the accessed data sets, and returning a listing result updateable in any appropriate frequency or measure.

In this regard, it will be appreciated that the foregoing functionality may be performed on and/or by the system disclosed herein. For example, a common computer-executed system may identify a plurality of remote listing sources and generate a listing result at least partially based on identifying associations between pre-search source data and/or criteria-specific data. The same computer-executed system may also generate the listing result in any other appropriate manner or embodiment, as will be discussed in more detail below.

Reference will now be made to the accompanying drawings, which assist in illustrating the various pertinent features of the various novel aspects of the present disclosure. The following description is presented for purposes of illustration and description. Furthermore, the description is not intended to limit the inventive aspects of the forms disclosed herein. Consequently, variations and modifications commensurate with the following teachings, and skill and knowledge of the relevant art, are within the scope of the present invention.

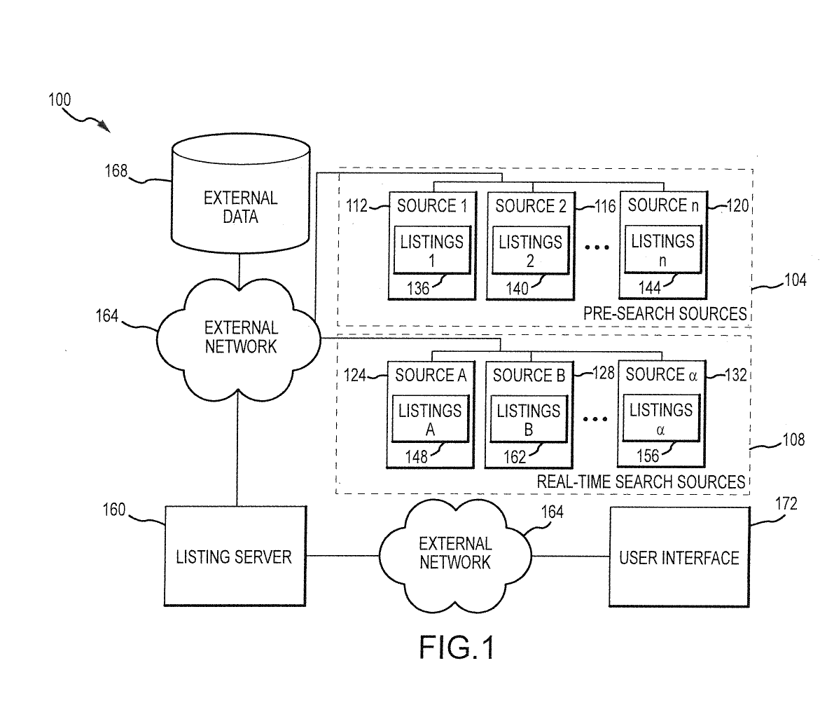

In this regard, FIG. 1 presents a functional block diagram of an illustrative distributed network 100 in which listing data may be identified and collected by utilities (e.g., systems, methods, etc.) disclosed herein. Broadly, the distributed network 100 may include any appropriate hardware (e.g., computing devices, data centers, switches), software (e.g., applications, system programs, engines), network components (e.g., communication path interfaces, routers) and the like (not necessarily shown in the interest of clarity) for use in facilitating any appropriate operations of the network. The distributed network 100 may include at least two types of sources of listing data; namely, pre-search sources 104 and real-time search sources 108. In some instances, the distributed network may include only pre-search sources 104 or real-time search sources 108 (e.g., which may facilitate returning a listing result based on the pre-search sources 104 or real-time search sources 108, respectively).

In one embodiment, a plurality of pre-search sources 104 may include a plurality of remote listing sources 112, 116, and 120 (e.g., web servers, etc.) and a plurality of real-time sources 108 may include a plurality of remote listing sources 124, 128, and 132 (e.g., web servers, etc.). One or more vehicle listings may reside within each of the plurality of pre-search sources 104 and the real-time search sources 108. For example, pre-search source listings 136, 140, and 144 may correspondingly reside at pre-search sources 112, 116, and 120, and real-time listings 148, 152, and 156 may correspondingly reside at real-time search sources 124, 128, and 132. Broadly, listing data, which corresponds to a physical vehicle offered for sale, may be associated with each of the foregoing listings, and, as will be discussed in more detail below, accessed by a processor to identify vehicle listings in distributed network 100.

Listing server 160, for example, may access pre-search sources 104, real-time search sources 108, and/or external data 168 (e.g., price data, etc.) over one or more external networks 164 (e.g., Internet, WANs, LANs, etc.) in any appropriate manner. As discussed in more detail below, the listing server 160 may, in response to received search criteria, access data received from pre-search sources 104, real-time search sources 108, and/or external data 168 to facilitate generation of a listing result at least partially based on the accessed data. In some embodiments, the listing server 160 may transmit the listing result to a user interface 172 over the one or more external networks 164.

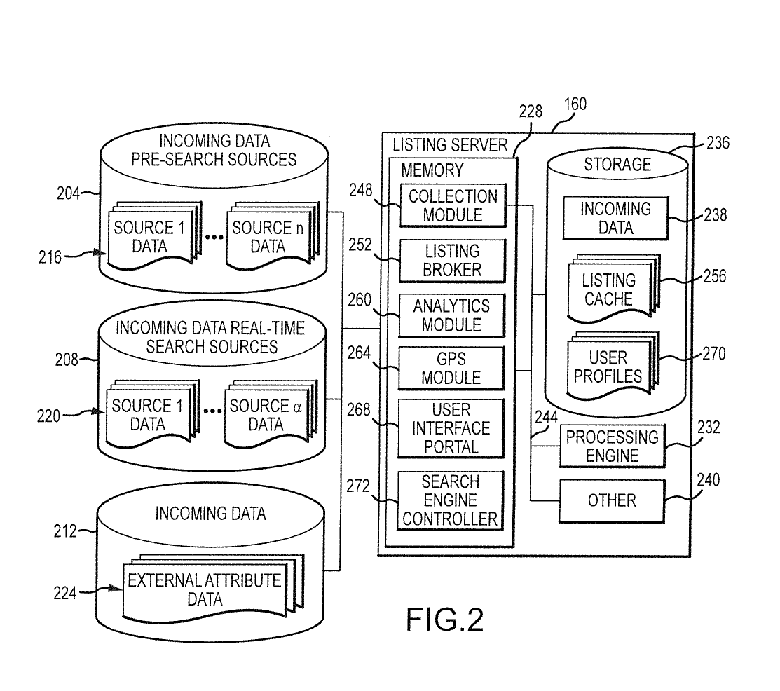

Turning now to FIG. 2, a more detailed functional block diagram of the listing server 160 is depicted for use in identifying and accessing vehicle listings in the distributed network of FIG. 1. That is, the listing server 160 is configured to identify, receive, and process incoming data associated with pre-search sources 204 (e.g., pre-search sources 104 of FIG. 1), incoming data associated with real-time sources 208 (e.g., real-time search sources 108 of FIG. 1), and/or incoming data associated with external data 212 (e.g., external data 168 of FIG. 1) transmitted over the one or more external networks 164 (not shown in FIG. 2) in order to support generating a listing result based on the identified vehicle listings within distributed network 100. For instance, incoming data associated with pre-search sources 204 may include pre-search source data 216, incoming data associated with real-time search sources 208 may include criteria-specific data 220 (i.e., data obtained from real-time source 208 in direct response to user criteria), and incoming data associated with external data 212 may include external attribute data 224.

Identification, collection, processing, and storage of each of the foregoing data types may facilitate identifying vehicle listings in distributed network 100 in response to a user inquiry. Pre-search source data 216 may include vehicle listings from a plurality of remote listing sources obtained in advance of listing server 160 receiving user criteria (or, in other words, not in response to user criteria) by collecting pre-search sources 104 for pre-search listings 136, 140, and 144, for example. In one embodiment, the listing server 160 normalizes the received pre-search source data 216 into a common data structure (e.g., such as a canonical listing object), indexes the data, and stores the same in any appropriate location (e.g., listing cache 256, etc.) to facilitate generating the listing result. In response to receiving user criteria, the listing server 160 may generate a listing result at least partially based on associations between the user criteria and the pre-search source data 216. In this regard, according to one embodiment, the listing result may be based on data accessed by the listing server 160 not in direct response to user criteria (i.e., the listing server 160 may search, normalize, index, and store the vehicle listings associated with the pre-search source data 216 prior to receiving user criteria).

In another embodiment, the listing server 160 may collect criteria-specific data 220 and generate a corresponding listing result (e.g., part of the previously mentioned listing result) in response to the listing server 160 receiving user criteria (e.g., parameters such as vehicle make, model, color, mileage, price, etc.). In this regard, a listing result may include vehicle listings associated with a plurality of pre-search sources 104 and real-time search sources 108. External attribute data 224 may include information associatable to the vehicle listings of the pre-search sources 104 and/or real-time search sources 108. For example, external attribute data 224 may include price data, GPS data, market trend data, and the like, for use in analyzing the generated listing result.

The listing server 160 may generally employ various components to identify and process pre-search source data 216 and/or criteria-specific data 220 to facilitate the generation of a listing result based on the identified and accessed vehicle listings in distributed network 100. As shown, the listing server 160 may include a memory 228 (e.g., one or more RAM or other volatile memory modules) that contains one or more modules or engines that process incoming pre-search source data 216, criteria-specific data 220, and/or external attribute data 224; a processing engine 232 (e.g., one or more processors, processing engines, CPUs, etc.) that executes the modules or engines from the memory 228; storage 236 (e.g., one or more magnetic disks, solid state drives, or other non-volatile memory modules) for storing incoming data 238, namely, pre-search source data 216, criteria-specific data 220, and/or external attribute data 224 (discussed in more detail below); and a number of other components 240 (e.g., input devices such as a keyboard and a mouse, output devices such as a display and speakers, and the like), all of which may be appropriately interconnected by one or more system buses 244.

The one or more engines of the listing server 160 generally facilitate the processing of pre-search source data 216, criteria-specific data 220, and/or external attribute data 224 by performing a plurality of incoming functions and storing resultant data in one or more databases of storage 236 (e.g., for use in generating a listing result). Each of the engines (and/or other engines, modules, logic, etc. disclosed and/or encompassed herein) may be in the form of one or more sets of computer-readable instructions for execution by the processing engine 232 and that may be manipulated by users in any appropriate manner to perform analysis of pre-search source data 216, criteria-specific data 220, and/or external attribute data 224 as disclosed herein. In this regard, the combination of the processing engine 232, memory 228, and/or storage 236 (i.e., machine/hardware components) and the various engines/modules disclosed herein in one embodiment create a new machine that becomes a special purpose computer once it is programmed to perform particular functions of the utilities disclosed herein (e.g., pursuant to instructions from program software). While various engines have been depicted in FIG. 2 as being separate or distinct engines, it is to be understood that the functionalities or instructions of two or more of the engines may actually be integrated as part of the same computer-readable instruction set and that the engines have been depicted in the manner shown in FIG. 2 merely to highlight various functionalities of the system.

In one arrangement, the listing server 160 may include a collection module 248 that identifies and collects pre-search source data 216 over the one or more external networks 164 from the pre-search sources 104 and stores the pre-search source data 216 in storage 236 in any appropriate manner (e.g., in one or more databases). The collection module 248 may be operable to methodically examine a plurality of pre-search sources 104 for pre-search listings 136, 140, 144 (see FIG. 1) to identify pre-search source data 216 and download pre-search source data 216 to a database of listing server 160, such as in storage 236. For example, the collection module 248 may employ various techniques for collecting pre-search source data 216, including web crawling, data scraping, API-based data extraction, and the like.

Each data source type may have at least one driver written for it, even in the case where there are multiple sites for a given source. The driver may be triggered by a listing broker 252 of the listing server 160 (where the listing broker 252 works in conjunction with or is part of the collection module 248) when it is time to perform each of the below-discussed crawling tasks. The role of the driver in the crawling tasks is to translate the specific semantics of the source site into canonical search tasks. For example, a driver will know how to acquire data for a resource, either an index or listing source data itself. As another example, the driver will also know how to parse that data and format it in a canonical data structure. The driver will then return the canonical objects to the listing broker 252 in response to the listing broker 252 prompting the driver to execute a task against the source site. The listing broker 252 may issue the following tasks against each driver: listIndexes, retrieveIndex, retrieveListing.

The collection module 248 may employ or otherwise obtain access to an index crawler (e.g., which may be implemented by listing broker 252) that provides information indicative of vehicle listings contained at various data sources (e.g., pre-search sources 104 and/or real-time search sources 108, etc.). For example, the index crawler may provide a listing of all active or current vehicle listings associated with a given data source, or it may include information representative of recently updated or published vehicle listings at the data source. The data provided by the index crawler may be monitored in any appropriate frequency or manner in order to identify vehicle listings suitable for accessing in relation to the vehicle search. For example, the data may be monitored for “new” vehicle listings (e.g., active listings that correspond to vehicle listing data that is not recognized as being previously stored at the database) suitable for subsequent download and analysis.

The index crawler may perform a number of functions in relation to identifying and collecting source data on a regular interval. For instance, the listing broker 252 may ensure it has the latest indexes (e.g., lookup structures that facilitate identifying or locating the existence of data quickly without actually having to search for it) for a particular source by calling listIndexes( ) method on each driver. Any new indexes may be inserted into an index queue (e.g., list of tasks to perform, possibly fully parallel, throttled parallel (N tasks at a time at most out of M>N total tasks to perform), or one at a time). Any indexes that are missing from the returned set may be removed from the index queue to ensure that the circular index queue (described below) processes the correct set of indexes for all sites.

The index may be checked regularly to determine what listings exist on the source. For complete inventory indexes, the frequency of checks may be dependent on how quickly discovery of new listings on that source is desired. For instance, sliding window indexes may need to be pulled often enough to ensure that new listings are seen before disappearing from the index. The listing broker 252 may obtain a canonical form of the index desired by calling retrieveIndex( ) on the driver identified by the index record. The driver may then return a canonical list of listing references.

The listing broker 252 may filter through the result set identifying which listings do not exist in the database where new listings may be kept and existing listings may be discarded. New listings may be queued for retrieval in the listing queue. The minimum requirements for queuing a listing for retrieval may be name of the source, identifier of the listing from the source, and the URL where the listing is located.

The set of indexes to check (the index queue) may be a circular queue so that as indexes ready to be pulled are consumed, they are reinserted at the back of the queue so that they get pulled again at regular intervals. The index queue may be a priority queue also so that sources with higher frequencies may loop through the circular queue faster than those indexes which do not need as frequent pulls.

The queue may be implemented as a schedular to avoid queue starvation (i.e., to avoid the inability of items in a queue to executed due to other items being inserted into the queue ahead of such items). Specifically, the entries in the queue may be ordered by, and executed in order of, one or more time stamps. For example, if a high priority entry and a low priority entry are queued at the same time, the higher priority item may run before the lower priority item by inserting the items with a next time to run timestamp. While the next time to run timestamp may also be the earliest the entry will run, it may be delayed while lower priority items are processed to avoid starvation.

In some instances, various different data sources may be monitored according to programs (e.g., frequencies, methods, etc.) particular to the respective source monitored. For example, a first source may be monitored (accessed) every 30 minutes, while a second source may be monitored every four hours (e.g., reflecting, for example, a rate at which the data may be updated at the respective source). In this regard, as different data sources may be associated with different monitoring frequencies and/or priorities, the invention may facilitate managing the tasks associated with the monitoring of the respective data sources by employing a queue starvation avoidance protocol.

The collection module 248 may also employ a listing crawler to access the data identified by the index crawler (e.g., such as pre-search source data 104 corresponding to “new” vehicle listings). In other words the listing crawler may serve to retrieve the data for the actual listings. For example, the listing crawler may process items off the listing queue (where the listing queue had items inserted into it by the above-discussed index crawler). As the listing queue may be linear, items may not be reinserted into the queue once removed therefrom. When the listing crawler has a listing entry to retrieve, it may call retrieveListing on the driver for that listing's respective source. The driver may then retrieve the raw data from the source for that specific listing, parses the data, and format it into a canonical listing object.

The listing broker 252 may then take the object returned by retrieveListing( ) and further enrich the data. For instance, this may include tasks such as removing duplicate image URLs, cleaning HTML tags out of descriptions and titles, ensuring missing city or state are populated from GPS coordinates, ensuring that missing GPS coordinates are populated from city and state, ensuring phone numbers and email addresses are properly formatted, etc. Finally, the listing broker 252 may store the listing in the listingCache database (e.g., listing cache 256). Once the listing is in the cache, it may be available to be returned by search inquires to the broker from the search engine controller 272.

Once raw data for a listing has been acquired, the data may be extracted from the context and used to facilitate an initial normalization of the obtained data by translating each data segment into a common data format (e.g., a canonical listing object). For instance, the context may be an HTML document wrapped around the data, data that exists in natural language, such as a user provided title or description, XML, etc. The driver for each source is configured to understand the raw data well enough to convert it to a canonical object. The canonical objects returned by drivers may still be a “rough cut”. That is, the data may be generally parsed and partitioned but may have some additional polishing required. The listing broker 252 may handle the final polishing of the data which is stored in the canonical object. For instance, polishing may include removing excess whitespace, fixing spelling errors, or addressing any other issue which is common across sources.

As the methods of normalization, both those specific to each source implemented in each driver, as well as the universal normalization tasks applied at the broker level, may constantly change, the implementation of the drivers and brokers must be such that the normalization process can be easily augmented to account for changing problems in the sources. For instance, normalization tasks may include extracting the year, make and model, zip code from the listing by using valid possible values as well as aliases for those values and searching for them in the source data. Also, normalization tasks may include extracting data which has typical patterns but for which there are too many possible values to have a pre-identified list of valid values (e.g., price, mileage, VIN, email, phone number, GPS location, image URLs, etc.). Also, missing data (e.g., zip/city/state from GPS and vice versa, Make/Year from Model (when model is distinct enough), etc. may be filled in as appropriate. Still further, free response text may be polished such as by removing HTML and extra whitespace from titles and descriptions. For instance, the objects may be compared with those of other sources that correspond to “vehicle model,” notwithstanding the potentially varying format of such data segments at each respective source.

To identify updates or changes in listings already stored in the listing cache 256 (e.g., in relation to price, images, etc.), an update crawler may initially determine which listings to process based on their “updated” time stamp which indicates the exact time the listing was last updated or when the listing was created if the listing is new and has not had an update yet. The listing broker 252 is essentially using the listing database as a circular processing queue ordered by updated timestamp. Once a listing is identified as needing an update, the URL of listing may be passed to the respective driver for that listing via the retrieveListing( ) method. The driver may then pull the listing and parses the data when the broker calls retrieveListing( ). The listing broker 252 may then compare the returned listing object to the one in the database and update any changed fields. Otherwise, the updated timestamp may be the only entry changed on the listing.

The listing server 216 may also include search engine controller 272 that is configured to communicate with the listing broker 252 and generate a listing result that is at least partially based on identifying associations between pre-search source data 216 and received user criteria. More particularly, the listing broker engine 252 may provide access to the vehicle listings stored at the listing server 160 such that the search engine controller 272 may extract the relevant listings for a particular search.

For example, the search engine controller 272 may receive a particular search criteria from a user (e.g., via user interface portal 268) that is defined by any appropriate parameters (e.g., vehicle type, year, location, price, etc.). For instance the search criteria may be due to a search being manually created/edited by a user or an existing search ready to be refreshed. In either case, the search engine controller 272 may pass the search parameters to the listing broker 252, such as via a call to getListings( ) method. The listing broker 252 may then stream the results back to the search engine. Upon receipt, the search engine controller 272 may determine whether the listings returned are new, existing or removed relative to the listings already stored for that search.

Listings identified as part of a search may be stored (e.g., in storage 236) using a listing pointer, where the listing point may be an object that contains a reference to the listing object in the broker database fields (e.g., in the listing cache 256) used to sort listings in a search as well as some of the data which relates the listing to the search. For example, relative fields relating the listing to the search may be distance (e.g., how far is the listing from the search location if provided on the search which would be null if search has no location or distance), status (e.g., new, viewed, deleted within the context of the search), removed (e.g., boolean field identifying if the listing has been removed from the source such as deleted, sold, ended, etc. Additional fields stored on the pointer for sorting purposes: may include price, created, contacted, etc.

In the event the listing is new, a new pointer may be inserted with status: new, removed: false, contacted: false, and all other fields populated relative to the listing. If the listing is removed, the listing pointer has removed set to true. If the listing is updated, all relative fields are calculated off new data and updated on the listing pointer. The search engine controller 272 may process stored searches based on lastRun, a timestamp on each search object identifying the last time the search was run or otherwise had listings inserted/updated/removed programmatically. A user deleting or modifying a listing pointer on a search may not change the search's lastRun timestamp.

The search engine controller 272 may manage multiple vehicle searches for a user simultaneously (e.g., each corresponding to different search criteria, etc.) and facilitate updating the searches on an ongoing basis (e.g., by subsequently querying the listing broker engine 252 in order to obtain new or updated data relevant to the particular user search criteria). In some embodiments, the search engine controller 272 may be operable to search, in response to receipt of the user criteria, a plurality of real-time search sources 108 for criteria-specific data 220. In this regard, the listing result may be at least partially based on criteria-specific data 220, and combinatively stored in listing cache 256 with the listings associated with the pre-search source data 216.

The listing result may be associated with external attributes data 224 by the operation of analytics module 260 and GPS module 264. For example, analytics module 260 may be operable to associate price data, received from external data 168, with a listing stored in listing cache 256. Similarly, GPS module 264 may be operable to associate GPS positioning data, received from external data 168, with a listing stored in listing cache 256. In this regard, analytics modules 260 and GPS module 264 may facilitate an analysis of the listing of listing cache 256 with respect to current market trends (e.g., by comparing a particular vehicle listing to an average price of a similar listing in a prescribed geographic region). The listing server 160 may also include a user interface portal 268 that is configured to receive data from a user device (e.g., via a web browser or the like), such as the user criteria used to identify associations in pre-search source data 216. Received data from user interface portal 268 may be used to create unique user profiles 270 in storage 236.

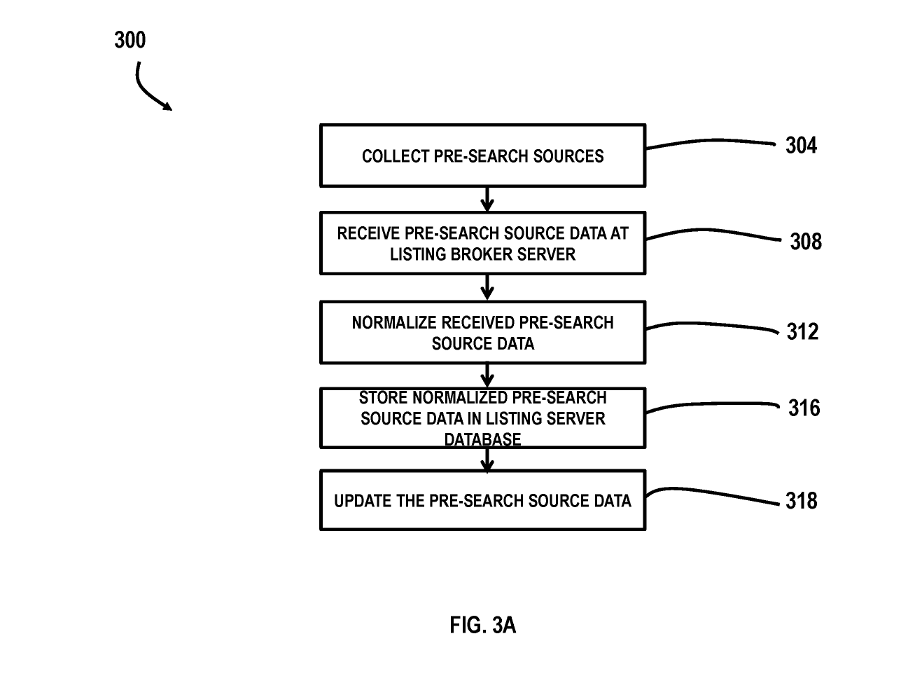

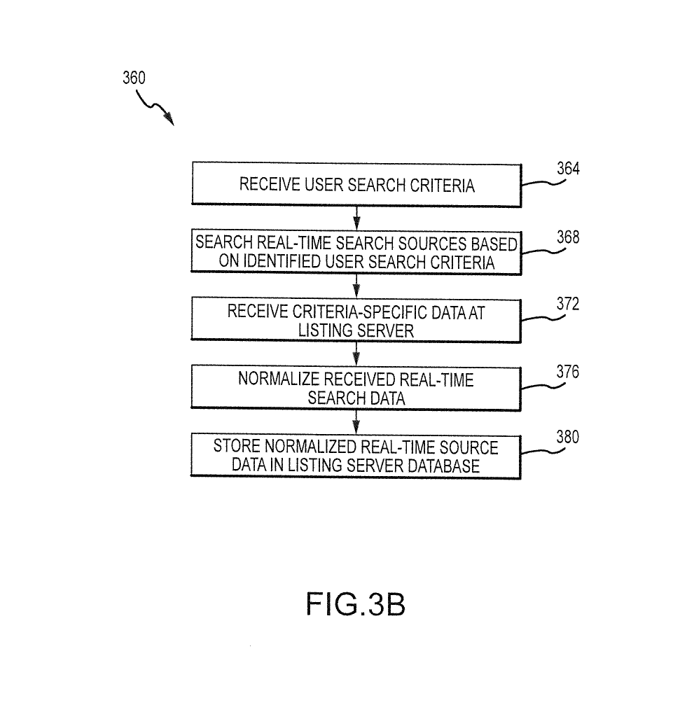

To further facilitate the reader's understanding of the various functionalities of the utilities discussed herein, reference is now made to flow diagrams in FIGS. 3A, 3B, 4, and 5, which respectively illustrate methods 300, 360, 400, and 500 for use in generating a listing result based on the identified vehicle listings within distributed network 100. While specific steps (and orders of steps) of methods 300, 360, 400, and 500 have been illustrated and will be discussed, other methods (including more, fewer or different steps than those illustrated) consistent with the teachings presented herein are also envisioned and encompassed with the present disclosure.

With initial reference to FIG. 3A, method 300 relates generally to identifying vehicle listings within distributed network 100 from a plurality of pre-search sources 104. The steps of method 300 may occur at one or more of the pre-search sources 104 (e.g., sources 136, 140, 144 of FIG. 1) in distributed network 100 and at listing server 160. The method 300 may include collecting 304 pre-search sources (e.g., by collection module 248 of FIG. 2) in distributed network 100 (e.g., such as by methodically examining a plurality of pre-search sources 104 to identify pre-search source data 216). The method 300 may continue by receiving 308 pre-search source data at the listing server (e.g., such as by downloading the pre-search data source data 216 from at least one of the plurality of pre-search sources 104 over external network 164). In one embodiment, the received pre-search source data 216 may be normalized 312 at the collection module 248 and/or listing broker 252 such that the pre-search source data 216 may conform to a common data structure. For instance, each of the plurality of pre-search sources 104 may use a unique data or semantic structure to represent a similar listing (e.g., a listing associated with a Nissan GTR® on remote listing source 112 may comprise a different semantic structure than a listing associated with a Nissan GTR® on remote listing source 116).

In this regard, listing server 136 may receive various data structures across the plurality of pre-search sources 104 and combinatively aggregate the various data structures into a common data structure for subsequent data manipulation. As such, listing server 160 may facilitate storing 316 the normalized pre-search source data in a database of the listing server. Additional embodiments may allow for indexing the normalized pre-search source data such that the normalized pre-search source data may be arranged in a manner that facilitates identifying associations between the normalized pre-search source data and user criteria. Accordingly, the normalized pre-search source data may be searched by a user in response to a received user query. The method 300 may further include updating 318 the pre-search source data in response to one or more preprogrammed and/or user-provided criteria. For example, in one embodiment, pre-search source data may be updated in response to a comparison of a corresponding timestamp of the pre-search source data and an update criteria indicative of a rate at which the pre-search source data may be updated (e.g., every five days, etc.).

Turning now to FIG. 3B, method 360 relates generally to identifying vehicle listings within distributed network 100 from a plurality of real-time search sources 108. Analogous to method 300 with respect to pre-search sources 104, the steps of method 360 may occur at one or more of the real-time search sources 108 (e.g., sources 124, 128, 132 of FIG. 1) in distributed network 100 and at listing server 160. The method 360 may include receiving 364 user search criteria at user interface portal 268 of listing server 160 (e.g., via a user interface 172 of FIG. 1). For instance, user criteria may include attributes or parameters associated with vehicle type (e.g., make, model, class), vehicle features (e.g., color, entertainment options, upholstery), vehicle traits (e.g., mileage, price range, geographic constraints) or other relevant criteria. Method 360 may continue by collecting vehicle listing from the real time search sources 108, such as by searching 368 real-time search sources based on the receiver user search criteria and receiving 372 criteria-specific data 220 at the listing server 160 (e.g., such as by downloading criteria-specific data 220 from at least one of the plurality of real-time search sources 108 over external network 164). For example, the real-time search may be executed by search engine controller 272, where search engine controller 272 downloads criteria-specific data 220 from the plurality of real-time search sources 108 over and through one or more appropriate application program interfaces or APIs. In this regard, user criteria may be transmitted to the plurality of real-time search sources 108 through the API, which, in turn, allows the search engine controller 272 to receive criteria-specific data 220 through the API from the plurality of real-time search sources 108. As such, listing server 160 receives criteria-specific data 372.

Analogous to the discussion of normalization of pre-search source data, in one embodiment the received criteria-specific data 220 may be normalized 376 at listing broker 252 such that the criteria-specific data 220 may conform to a common data structure. In this regard, listing server 160 may receive various data structures across the plurality of real-time search sources 108 and combinatively aggregate the various data structures into a common data structure for subsequent data manipulation. As such, listing server 160 may facilitate storing 380 the normalized criteria-specific data in a database of the listing server.

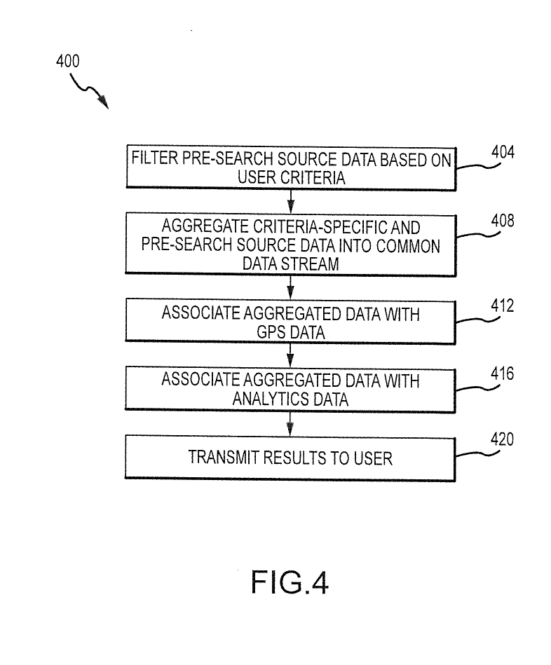

Turning now to the method 400 of FIG. 4, normalized pre-search source data and normalized criteria-specific data may be combinatively aggregated and associated with external attribute data 224 to generate listing results. Method 400 may begin by filtering 404 pre-search source data based on received user criteria (e.g., by identifying associations between pre-search source data 216 and the received user criteria at listing broker 252). For instance, pre-search source data 216 that does not satisfy user criteria requirements may be excluded from the pre-search source data stored in listing cache 256, such that only pre-search source data 216 that does satisfy user criteria requirements may be included in the listing result (e.g., if the user criteria specified luxury sedans, pre-search source data 216 which did not include luxury sedans would be excluded from listing cache 256). Method 400 may continue by aggregating 408 the criteria-specific data and filtered pre-search source data into a common data stream, such as at listing broker 252 of listing server 160. The aggregated common data stream may constitute the listing result and be stored in listing cache 256 of storage 236 for consideration by the user. In other instances, the listing result may include only the filtered pre-search source data or the criteria-specific data.

In some embodiments, the aggregated data of the listing cache may be associated with various external attribute data 224 to facilitate consideration of the listing result by the user. For instance, method 400 may include associating 412 aggregate data with GPS data at GPS module 264 and/or associating 416 the aggregated data with analytics data at analytics module 260. Method 400 may continue by transmitting 420 results to a user, such as via user interface portal 268. In some embodiments, listing server 160 may transmit the results wirelessly over external network 164 to user device 172. In any case, the user may consider the listing result in a plurality of contexts that may facilitate vehicle selection among the plurality of listing results.

For example, GPS data may be used to associate a particular vehicle listing with similarly situated vehicle listings in a defined geographical area. Analytics data may be used to associate a particular vehicle listing with aggregate statistics of similar vehicle qualities (e.g., average price of a vehicle with similar mileage, and the like). In other embodiments, GPS module 264 may be used in operative conjunction with analytics module 260 to constrain the application of aggregate statistics to a defined geographical area.

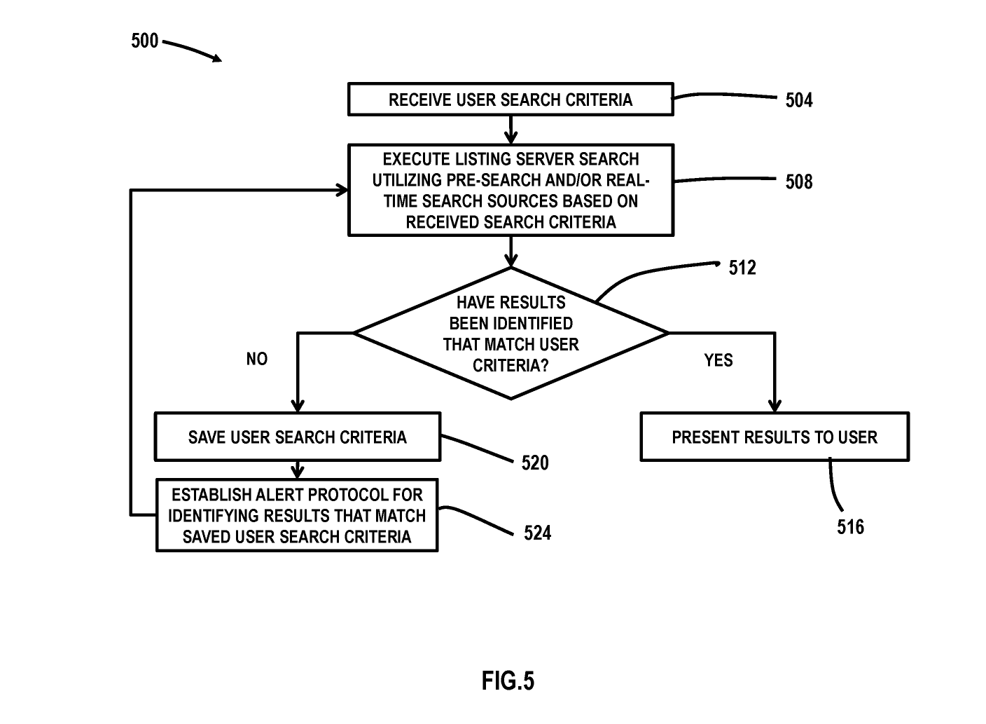

Turning now to FIG. 5, method 500 relates generally to a method for use in identifying a vehicle listing in the distributed network 100 of FIG. 1 based on saved user search criteria. The method 500 may include receiving 504 user search criteria at listing server 160. As discussed with respect to FIG. 3b, user search criteria may be based on various vehicle attributes associated with a desired vehicle, as determined by the user. The method 500 may continue by executing 508 a listing server search utilizing pre-search and/or real-time search sources based on received search criteria, as generally described in methods 300, 360, and 400, and querying 512 whether results have been identified that match received user search criteria. An identified match may depend on the restrictiveness of the received search criteria in relation to the listings associated with pre-search sources (136, 140, 144) and the listing associated with real-time search sources (148, 152, 156). In some instances, a plurality of matches may be identified and combinatively aggregated to create a listing result, which may be presented 516 to the user.

In other instances, where a match may not be identified, listing server 160 may save 520 user search criteria in user profiles 270 of storage 236. In response to saving user search criteria, listing server 160 may establish 524 an alert protocol identifying results that match saved user search criteria. In this regard, process step 508 may be re-executed based on the saved user search criteria and associated alert protocol. The subsequently re-executed search may facilitate ongoing searches based on narrow user search criteria. For example, a user may desire to find a rare vehicle not presently contained within any listing in the pre-search sources 104 or real-time search sources 108. Method 500 may allow a user to continuously search pre-search sources 104 and real-time search sources 108 until it locates a listing which does contain the rare vehicle. Alerting the user to the identified match may allow for continuous re-execution of the search without subsequent interaction from the user until the listing server 160 identifies the match.

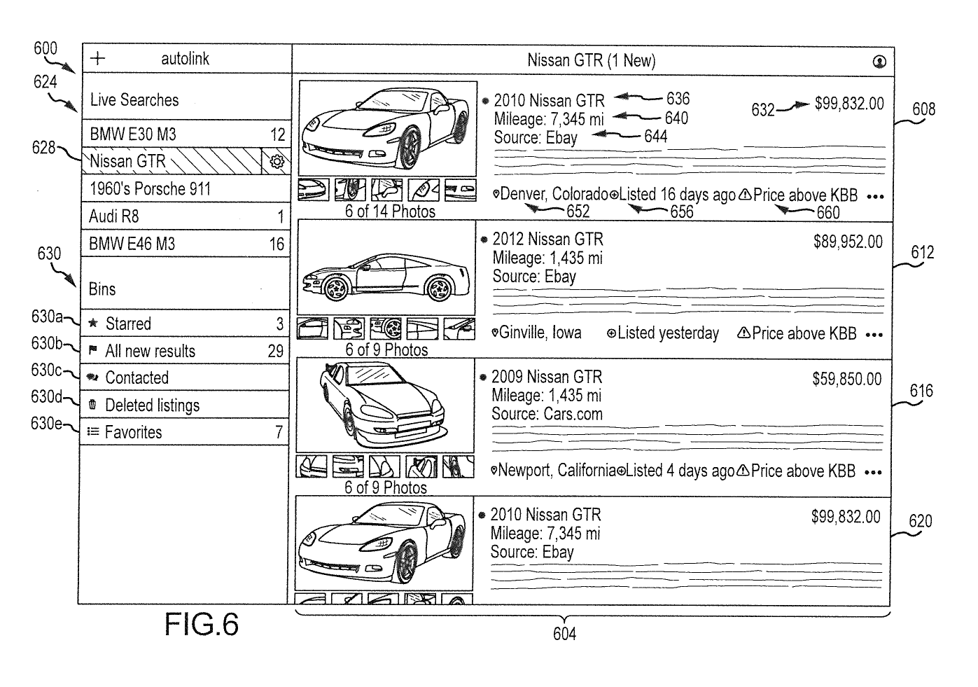

FIG. 6 presents a screenshot 600 of the user interface portal 268 of FIG. 2 as may be presented on the user interface 172 of FIG. 1. The screenshot 600 includes listing result 604, which as discussed above with respect to methods 300, 360, and 400, may be based on pre-search source data 216 and/or criteria-specific data 220. Normalizing pre-search source data 216 and/or criteria-specific data 220 into a common data format allows the listing result to appear in a uniform fashion.

In this embodiment, implementation picture 600 shows listing result 604 with four identifiable vehicle listings (608, 612, 616, 620) that correspond to a live search of the Live Searches task bar 624 (which, in this case, is a Nissan GTR search 628). While each of the four identifiable vehicle listings (608, 612, 616, 620) may originate from various search types (e.g., pre-searching, real-time searching), various data sources (e.g., pre-search sources 112, 116, 120), and various data structure (e.g., due in part to the normalization of the received data) listing result 604 may uniformly display each data field associated with the respective listing, such as, listing price 632, listing name 636, listing mileage 640, listing source 644, and listing description (not labeled). Any of the identifiable vehicle listings (608, 612, 616, 620) may be stored in one or more bins 630 in order to facilitate subsequent review of the vehicle listing without executing a new listing server search. Each of the bins 630 may be associated with an attribute corresponding to a status of the vehicle listing (e.g., starred 630a, all new results 630b, contacted 630c, deleted listing 630d, favorites 630e, and the like). In this regard, bins 630 may facilitate sorting and reviewing of the identifiable vehicle listings (608, 612, 616, 620) through the categorization of the vehicle listings at least partially based on identified shared attributes.

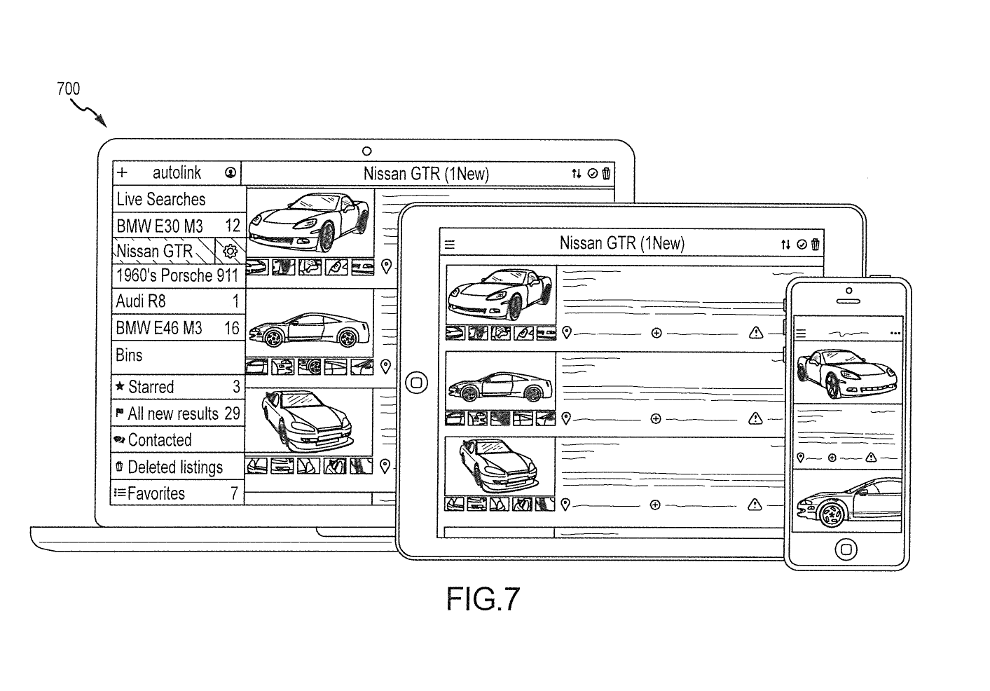

Listing result 604 may also include information at least partially based on external data attributes 224, such as those described with respect to GPS module 264 and analytics module 260, both of FIG. 2. In this embodiment, listing location 652 may indicate the metropolitan location of the vehicle of the listing, as may be determined by GPS module 264. Further, listing time 656 may indicate the duration of time a particular listing has been available on a given listing source, as may be determined by analytics module 260. Additionally, listing price comparator 660 may indicate the relative price of the vehicle in relation to third party price data, such as that provided by the Kelly Blue Book®. FIG. 7 presents the screenshot 600 of FIG. 6 shown on a plurality of wireless-enabled devices 700 (e.g., user interfaces 172).

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. For instance, in some embodiments, a remote listing source could be considered a pre-search listing source and a real-time listing source. In other embodiments, a remote listing source may not correspond to a physical vehicle offer for sale, but may be applicable to other contexts, such as motorcycle listings, boat listings, airplane listings, all-terrain vehicle listings, real estate listings, and the like.

Embodiments disclosed herein can be implemented as one or more computer program products, i.e., one or more modules of computer program instructions encoded on a computer-readable medium for execution by, or to control the operation of, data processing apparatus. For example, the logic or software of crawler module 248, listing broker 252, analytics module 260, GPS module 264, user interface portal 268, and search engine controller 272 responsible for the various functionalities disclosed herein may be provided in such computer-readable medium of the listing server 160 and executed by the processing engine 232 as appropriate. The computer-readable medium can be a machine-readable storage device, a machine-readable storage substrate, a non-volatile memory device, a composition of matter affecting a machine-readable propagated signal, or a combination of one or more of them. In this regard, listing server 160 may encompass one or more apparatuses, devices, and machines for processing data, including, by way of example, a programmable processor, a computer or multiple processor or computers. In addition to hardware, the listing server 136 may include code that creates an execution environment for the computer program in question, e.g., code that constitutes processor firmware, a protocol stack, a database management system, an operating system, or a combination of one or more of them.

A computer program (also known as a program, software, software application, script, or code) used to provide the functionality described herein may be written in any form of programming language, including compiled or interpreted languages, and may be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by an information flow network.

The block diagrams, processes, protocols and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Generally, the elements of a computer are a processor for performing instructions and one or more memory devices for storing instructions and data. The techniques described herein may be implemented by a computer system configured to provide the functionality described.

In some embodiments, the listing server 160 may comprise one or more of various types of devices, including, but not limited to a personal computer system, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or, in general, any type of computing or electronic device.

The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A method for use in identifying vehicle listings within a distributed network, comprising:
first searching, over one or more networks, a plurality of first remote listing sources for first vehicle listing data, the first vehicle listing data including a plurality of data segments, each data segment of the plurality of data segments representing a listing attribute of the respective remote listing source and defined by a different respective data format;
storing the first vehicle listing data in a database of a listing server;
receiving, at a processor of the listing server, after the storing, search criteria from a user;
identifying, by the processor, associations between the stored vehicle listing data and the search criteria; and
returning a listing result that is at least partially based on the identified associations.

2. The method of claim 1, wherein the first searching comprises identifying the first vehicle listing data associated with each respective one of the plurality of first remote listing sources.

3. The method of claim 2, further comprising:
determining a subset of the identified first vehicle listing data associated with each respective one of the plurality of first remote listing sources as active listings.

4. The method of claim 3, wherein the storing comprises accessing the active listings such that the active listings are stored in the database.

5. The method of claim 3, wherein the active listings correspond to instances of the identified first vehicle listing data that are not recognized as being previously stored at the database.

6. The method of claim 1, further comprising:
first normalizing, by the processor, the plurality of data segments of the first vehicle listing data such that the plurality of data segments are defined by a common data format; and
first indexing, by the processor, the normalized first vehicle listing data according to the listing attribute of at least one of the data segments of the plurality of data segments,
wherein the listing result is at least partially based on the indexed first vehicle listing data.

7. The method of claim 6, wherein the first normalizing comprises accessing a source driver for each of the plurality of first remote listing sources that translates each data segment associated with the respective source into the common data format.

8. The method of claim 7, wherein each of the translated data segments comprises a canonical listing object.

9. The method of claim 6, wherein a first segment of first vehicle listing data defined by a first data format identifies a first vehicle, and wherein a second segment of first vehicle listing data defined by a second data format identifies the first vehicle, and wherein the first and second data formats are different, and wherein the first and second segments of first vehicle listing data are defined by the common data format after the first normalizing.

10. The method of claim 6, further comprising:
second searching, in response to the receiving, a plurality of second remote vehicle listing sources for second vehicle listing data, each of the plurality of second remote listing sources including at least one data definition corresponding to a listing attribute of the respective second remote listing source, the second vehicle listing data including the subset of the plurality of second remote listing sources corresponding to the search criteria.

11. The method of claim 10, further comprising:
second normalizing, by the processor, the second vehicle listing data such that the at least one data definition of each of the plurality of second remote listing sources conforms to the common data format;
second indexing, by the processor, the normalized second vehicle listing data according to the at least one data definition of the plurality of first remote listing sources,
wherein the storing further comprises storing the indexed second vehicle listing data with the first indexed vehicle listing data in the database of the listing server.

12. The method of claim 11, wherein the listing result is at least partially based on the indexed second vehicle listing data.

13. The method of claim 12, wherein the normalized first vehicle listing data and the normalized second vehicle listing data are associated with GPS data corresponding to a physical location associated with the first vehicle listing data or the second vehicle listing data, and wherein the listing result is at least partially based on the GPS data.

14. The method of claim 12, wherein the normalized first vehicle listing data and the normalized second vehicle listing data are associated with analytics data, the analytics data being at least partially based on the listing attribute of the respective first remote listing source or the listing attribute of the respective second remote listing source, and wherein the listing result is at least partially based on the analytics data.

15. The method of claim 14, wherein the analytics data includes price data received from a third-party source distinct from any of the plurality of first remote listing sources of the plurality of second remote listing sources.

16. The method of claim 1, wherein the storing comprises saving the search criteria from the user in the database, and wherein the processor is operable to return the listing result at least partially based on the saved user criteria.

17. The method of claim 1, wherein the returning comprises providing an alert to the user in response to the returning of the listing result.

18. The method of claim 1, wherein the first searching comprises at least one of web crawling, data scrapping, or API-based data extraction.

19. (canceled)

20. (canceled)

21. A computer executed system on a computing device for identifying vehicle listings within a distributed network, comprising:
a collection module, executed by a processor of the computer executed system, that is operative to first search a plurality of first remote listing sources for first vehicle listing data and store the first vehicle listing data in a database of the system, the first vehicle listing data including a plurality of data segments, each data segment of the plurality of data segments representing a listing attribute of the respective first remote listing source and defined by a different respective data format;
a search engine controller, executed by the processor of the computer executed system, that is configured to receive search criteria from a user; and
a listing broker engine, executable by the processor of the computer executed system, that is configured to:
identify associations between the first vehicle listing data and the received search criteria; and
return a listing result that is at least partially based on the identified associations.

22-40. (canceled)

41. A method for use in identifying vehicle listings within a distributed network, comprising:
first searching, over one or more networks, a plurality of first remote listing sources for first vehicle listing data, the first vehicle listing data including a plurality of data segments, each data segment of the plurality of data segments representing a listing attribute of the respective first remote listing source and defined by a different respective data format;
first normalizing, at a processor of the listing server, the plurality of data segments of the first vehicle listing data such that the plurality of data segments are defined by a common data format;
first indexing, by the processor, the normalized first vehicle listing data according to the listing attribute of at least one of the data segments of the plurality of data segments; and
storing the indexed first vehicle listing data in a database of a listing server.

42-119. (canceled)
